(19) United States
(12) Patent Application Publication
(10) Pub. No.: US 2003/0204000 A1
(43) Pub. Date: Oct. 30, 2003

(54) Polyester composition reducing ultraviolet penetration and the polyester bottle manufactured from said polyester composition

(76) Inventor: Zo-Chun Jen, Taipei (TW)

Correspondence Address: CHAUNCEY JOHNSON, #282, 14625 BALTIMORE AVENUE, LAUREL, MD, 20707, US

(21) Appl. No.: 10/301,628

(22) Filed: Nov. 22, 2002

(30) Foreign Application Priority Data
Apr. 29, 2002 (TW) 91108890

(51) Int. Cl. C08L 1/00; C08J 3/00; C08K 5/16

(52) U.S. Cl. 524/186

(57) ABSTRACT

This invention discloses a novel polyester composition having ultraviolet light penetration reduction characteristics use to manufacture polyester bottles. The polyester composition of this invention results from mixing preferably 10-1000 ppm of azimido-benzene ultraviolet absorbent with preferably 0.01 to 2 mol % of 2,6 naphthalene dicarboxylate copolyester and pre-polymerized polyester of preferably over 98 mol %. Using precise concentration and mole ratios when forming the polyester composition of this invention is critical for reducing ultraviolet light penetration, and for keeping manufactured polyester bottles haze values to commercial acceptable levels.

### BACKGROUND OF THE INVENTION

This invention discloses a novel polyester composition having ultraviolet light penetration reduction characteristics use to manufacture polyester bottles. Specifically, this invention relates to a polyester composition comprising azimido-benzene ultraviolet absorbent, 2,6 naphthalene dicarboxylate copolyester and pre-polymerized polyester. In addition to having ultraviolet penetration blocking characteristics, the polyester composition of this invention is capable of producing polyester bottles with haze values maintained at commercial acceptable levels.

Polyester compounds use to manufacture polyester bottles include, but are not limited to, polyethylene terephthalate (“PET”), modified polyethylene terephthalate, polybutylene terphthalate (“PBT”) and polytrimethylene terphthalate (PPT). PET is the most commonly used polyester. PET is use to manufacture packaging materials, polyester bottles for containing drinks/beverages, such as aerated water, fruit juice, tea and forms of other edible materials. PET is the polymer of choice because of its lightness as compared to other polymers, its remarkable elasticity, good storability and its light penetration prevention characteristics.

Generally most polyester containers, irrespective of its polymer constituents, when exposed to sunlight over a period of time will deteriorate and fade after absorbing ultraviolet light. Most food compositions are photo-chemically influenced by ultraviolet light with wavelengths between 200-380 nm. To protect food compositions from being altered photo-chemically, polymers used in the manufacture of packaging and bottles must absorb ultraviolet light with wavelengths between 200 nm-380 nm. Most contemporaneous polyester packaging, containers and bottles, etc. do not absorb ultraviolet light between 200 nm-380 nm. For example, PET, the most common polyester bottle ingredient, absorbs ultraviolet light below wavelengths less than 315 nm. Thus manufacturing polyester bottles with ingredients capable of absorbing ultraviolet light with wavelengths between 315-380 nm is essential. To manufacture polyester bottles with ultraviolet absorbing characteristics, the traditional approach is to add ultraviolet absorbents into polyester compositions use to manufacture the bottles.

Ultraviolet absorbents can are divided into organic ultraviolet absorbents and inorganic ultraviolet absorbents. Examples of organic ultraviolet absorbents are salicylate, bensophenone, and azimido-benzene. Organic absorbents utilize their individual resonance structures to absorb ultraviolet light of various wavelengths. Examples of inorganic absorbents are titanium dioxide, zinc oxide, ferric oxide and ceria. In contrast to their organic counterparts, inorganic absorbents disperse and absorb ultraviolet rays by possessing the requisite particle sizes, having particles with high index of refraction and particles with the requisite tinct characteristics.

Attempts have been made to manufacture polyester containers with ultraviolet covering effect spanning wavelengths between 315 nm-380 nm. Japanese Patent Application Laid-Open No. 10-53696 discloses manufacturing polyester bottles with co-polyester containing naphthalene co-monomer, an organic absorbent, of 0.001-10 wt %. But naphthalene absorption of ultraviolet light, according to application 10-53696, was determined to be below 360 nm wavelengths only, and thus will be unsuitable for protecting a wide range of beverages/drinks from decay caused by exposure to ultraviolet light. This is because the resonance structure of naphthalene with two benzene rings does not wholly absorb and reduce the penetration effect of ultraviolet rays.

Other attempts to manufacture polyester bottles with ultraviolet covering effect above 360 nm wavelengths teach the use of inorganic absorbents rather than organic absorbents. The usual approach is to add small quantities of inorganic absorbents such as titanium dioxide, zinc oxide, ferric oxide and ceria, etc. to a polyester composition. These inorganic absorbents are particles with sizes ranging from 0.01 to 2.0 micrometers. Although using inorganic particles of such small size will initially have favorable dispersion and absorption effect on ultraviolet light of wavelength over 360 nm, overtime the inorganic particles will conglomerate and reduce their original penetration covering effect against ultraviolet light.

If particles between 0.01-2.0 micrometers are used to manufacture thick polyester bottles, such as 0.355 millimeter thick polyester bottles, the addition level of the inorganic particles would have to exceed 1000 ppm to compensate for the small inorganic absorbent particle sizes. The large use of inorganic particles in excess of 1000 ppm would increase the haze values of the polyester bottles manufactured.

It is an object of this invention to further improve the ultraviolet covering effect of polyester bottles, while maintaining or lowering the haze value of the manufactured bottles.

Another object of this invention is to manufacture polyester bottles with a polyester composition comprising naphthalene, azimodo-benzene and pre-polymerized polyester.

Still another object of this invention is to use critical mole and concentration ratios of naphthalene, azimodo-benzene and pre-polymerized polyester to form the polyester composition of this invention use to manufacture polyester bottles with reduced ultraviolet light penetration characteristics and with commercially acceptable haze value levels.

### SUMMARY OF THE INVENTION

This invention relates to a polyester composition use to manufacture polyester bottles with ultraviolet light penetration blocking characteristics. The polyester composition comprises naphthalene, azimodo-benzene and pre-polymerized polyester. In addition to having ultraviolet penetration blocking characteristics, the polyester composition of this invention is capable of producing polyester bottles with haze values maintained at commercial acceptable levels.

The polyester composition of this invention results from mixing preferably 10-1000 ppm of azimido-benzene ultraviolet absorbent with preferably 0.01 to 2 mol % of 2,6 naphthalene dicarboxylate copolyester and pre-polymerized polyester of preferably over 98 mol %.

Specifically, this invention uses Ciba Geigy Corporation's TINUVIN * 234 as the preferred organic absorbent of choice. Like other organic absorbents, TINUVIN * 234 absorbs ultraviolet irradiation by the use of its special resonance structure. The hydroxy (OH) group and the nitrogen (N) group of the TINUVIN * 234 absorbent form inner molecular hydrogen bonding, which causes resonance effect and absorb ultraviolet irradiation.

The process through which 2,6-naphthalene dicarboxylate and TINUVIN * 234 ultraviolet absorbent are added to the polyester composition begins with milling 2,6-naphthalene dicarboxylate into powder form and adding ethylene glycol (EG) to form a slurry.

### DETAILED DESCRIPTION OF THE INVENTION

To produce polyester bottles capable of absorbing and reducing ultraviolet light penetration at variable wavelengths, the inventor through careful review and research, proposes manufacturing polyester bottles with polyester composition comprising naphthalene co-monomers and azimido-benzene ultraviolet absorbent. Polyester bottles manufactured with a polyester composition comprising naphthalene and azimodo-benzene produced two significant results: bottles were found to drastically reduce ultraviolet light penetration; and their haze values were kept at a commercial acceptable levels.

A wide range of polyester resins can be used as starting materials for this invention. Generally polyester resins are produced from esterifying of a dibasic acid and a diol, or by transesterifying a diester such as dimethyl terephthalate (DMT) and a diol. The most used dibasic acid is terephthalic acid (TPA), modified or unmodified, and the most used diol is ethylene glycol (EG). It is well known that polyester resin compositions can consist of two or more dibasic acid and/or two or more diols. Example of acid ingredients that may be used to manufacture the polyester resin of this invention are iso-phthalic acid, succinic acid, glutaric acid, adipic acid, sebacic acid and/or mixtures of analog comprising any of the previously mentioned acids. Example of alcohol ingredients that may be used to manufacture the polyester resin of this invention are diethylene glycol, 1,3-propane glycol, 1,4-butane glycol and/or mixture of analog of any of the previously mentioned alcohol.

A common method of manufacturing polyester resins for to manufacturing polyester bottles reacts trephthalic acid and glycol preferably between 210 to 240° C. to form monomer and water. Water is continuously removed during reacting the terephthalic acid with the glycol. During the reaction, a catalyst or an accelerant is not required because adding a catalyst or accelerant will slightly speed up the reaction and reaction enhancement are not noticeable. Rather addition of accelerant or catalyst primarily increases diethylene glycol (DEG) production. After successful esterification of the terephthalic acid and the glycol, a condensation/aggregation reaction follows. The condensation/aggregation reaction comprises a pre-polymerization reaction and a main polymerization reaction.

The pre-polymerization reaction occurs preferably between 270-280° C. and at an operational vacuum pressure preferably between 250-15 mmHg. The main polymerization occurs preferably between 275 to 285° C. and at an operational vacuum pressure preferably below 1 mmHg. At these preferred temperatures and pressures the condensation/aggregation reaction is successfully performed. At the end of the condensation/aggregation of the PET melt phase, PET polymer intrinsic viscosity (IV) value usually increases from about 0.5 to 0.7 dl/g. At this point, the polymer is uploaded to the cooling water bath for quick chilling and subsequently cut into cylindrical ester chips.

In order to increase the intrinsic viscosity (IV) value of the PET polymer to obtain the desired polymer required to manufacture the polyester bottles, solid phase polymerization of the ester particles is performed at 200° C. in the presence of nitrogen gas, which increases the IV value to preferably between 0.7 to 1.1 dl/g, although increasing the IV from between 0.72-0.88 dl/g is strongly preferred. If the temperature of the solid phase polymerization is lower than 200° C., the intrinsic viscosity IV value slowly increases. At temperature below 200° C., the chances of performing a successful solid phase polymerization reaction needed to produce the desired polymer films are greatly reduced. The next series of steps involve crystallizing and drying the ester particles, molding the ester particles into parisons through the use of bottle blowing machine, and then blowing the ester particles to obtain bottles of desired shapes.

Manufacturing polyester bottles from resin compositions—lacking ultraviolet protection—using traditional methods as discussed above render bottles' contents vulnerable to ultraviolet irradiation. To overcome the effect of ultraviolet radiation on polyester bottles' contents, this invention teaches mixing preferably 10-1000 ppm of azimido-benzene ultraviolet absorbent with preferably 0.01 to 2 mol % of 2.6-naphthalene dicarboxylate copolyester and with pre-polymerized polyester of preferably over 98 mol %. Using the precise composition ranges specified in this paragraph for manufacturing is critical for reducing ultraviolet light penetration through the manufactured polyester bottles, while keeping the manufactured polyester bottles haze value levels to a minimum.

When polyester composition containing 2,6-naphthalene dicarboxylate is exposed to ultraviolet light, the hydrogen atom at its 2,6 position of the naphthalene dicarboxylate is replaced with COOCH₃ and the ultraviolet wave crest absorption wavelengths transitions from between 286 nm to 312 nm to between 345 nm and 365 nm. Thus, addition of small quantities of naphthalene dicarboxylate to synthetic polyester results in a polyester composition capable of effectively absorbing ultraviolet light below 360 nm wavelength. Naphthalene dicarboxylate is easily polymerized into the molecular chain of the polyester resin composition during the polymerization process. The polyester composition containing naphthalene co-monomer is fused and blown molded causing the plane with the naphthalene dual benzene ring structure to extend parallel along the bottles heading, thereby maximizing the absorption covering efficiency against ultraviolet irradiation.

To achieve even higher ultraviolet absorption efficiency, absorption above 360 nm wavelengths, this invention teaches the addition of organic ultraviolet absorbent, such as salicylate, benzophenone, and azimido-benzene, etc. to the polyester composition. These organic absorbents effectively absorb ultraviolet irradiation by the use of their special resonance structures. Through extensive research, the organic absorbent azimido-benzene has proven to be very effective against ultraviolet irradiation. Specifically, this invention uses Ciba Geigy Corporation's TINUVIN * 234 as the preferred organic absorbent of choice. Like other organic absorbents, TINUVIN * 234 absorbs ultraviolet irradiation by the use of its special resonance structure. The hydroxy (OH) group and the nitrogen (N) group of the TINUVIN * 234 absorbent form inner molecular hydrogen bonding, which causes resonance effect and absorb ultraviolet irradiation. As compared to other organic absorbents, such as salicylate and benzophenone, the azimido-benzene's electric resonance plane is larger in scope resulting in ultraviolet absorption along a wider wavelength spectrum,

Our research has shown that mixing a small quantity of TINUVIN * 234, between 10-1000 ppm, with polyester to form a polyester resin composition was effect against ultraviolet irradiation below wavelengths of 360 nm. The TINUVIN * 234/polyester mixture composition was not as effective against ultraviolet irradiation below wavelengths of 360 nm, as compared with polyester/0.01-2 mol % naphthalene mixture composition. However, the reverse was determined to be true when tested against ultraviolet irradiation above wavelengths of 365 nm. The inventor has discovered that by mixing both naphthalene and TINUVIN * 234 with polyester resin to form a mixed composition, it was indeed possible to drastically reduce ultraviolet penetration below 360 nm and above 360 nm without increasing the haze value of the polyester mixture composition.

The addition level of the 2,6-naphthalene dicarboxylate to the composition mixture should preferably be between 0.01-2.0 mol %, although between 0.1-1.0 mol % is strongly preferred. When the addition level of naphthalene falls below 0.1% mol, the ultraviolet covering effect for wavelengths below 360 nm is not apparent. When the addition level of naphthalene is above 1.0% mol, the ultraviolet covering effect for wavelength below 360 nm is moderate at best. The addition level of the TINUVIN * 234 to the composition mixture should preferably be between 10-1000 ppm, although between 200-500 ppm is strongly preferred. When the addition level of TINUVIN * 234 is below 200 ppm, the ultraviolet covering effect for wavelengths above 370 nm is not apparent. When the addition level of TINUVIN * 234 is above 500 ppm, the ultraviolet covering effect for wavelengths below 370 nm is moderate at best.

The process through which 2,6-naphthalene dicarboxylate is added to the polyester composition begins with the milling of 2,6-naphthalene dicarboxylate into powder form and adding ethylene glycol (EG) to form a 25 wt % slurry, which is then poured into a reaction vessel by means of gear pumps. The slurry containing the 2,6 naphthalene dicarboxylate can be added into the polyester process during the mixing of the diacid and glycol or during the esterification reaction process. Similarly, the TINUVIN * 234 absorbent is added to ethylene glycol (EG) to form 15 wt % slurry, and then poured into a reaction tank via gear pump. The slurry containing the TINUVIN * 234 absorbent can be added in the polyester process during the mixing of the diacid and glycol or during the esterification reaction process. In addition to the ingredients discussed in this paragraph, different additive such as hot stabilizer, light stabilizer, dye, coloring, plasticity agent, antioxidant, infrared absorbent, and uv-resistant agent, etc. can be added into the polyester composition of this invention.

The equipment used to measure the ultraviolet penetration analyses of the polyester bottle pieces is the ultraviolet spectrometer model SHIMADZU UV 2101PC. The equipment used to measure the haze value level is the color and color difference meter, model 1001 DP manufactured by NIPPON DENSHOKU KOGYO CO. LTD.

By way of examples of exploitations, the manufacturing processes, conditions and process components, though not limited to the exploitations, of the present invention may be as follows:

### EXAMPLES OF EXPLOITATION

### EXAMPLE OF EXPLOITATION 1

PET oligomer 12.11 Kg and EG 3.87 Kg are added into an electric heated stainless steel 30 litre reactor, agitated and heated under atmosphere to 260° C., and EG in the amount of 1200-1400 ml is collected. Before the condensation reaction, the following ingredients are subsequently added: 450 ppm antimony acetate condensation catalyst, 140 ppm cobalt acetate, 0.25mol % 2,6-naphthalene dicarboxylate and 300 ppm TINUVIN*234 uv-resistant agent.

Next, the reactor is vacuumed and decreased to pressures below 1 mmHg to perform the pre-polymerization reaction at a temperature of 270° C., and to subsequently perform the main polymer reaction at 280° C. to produce the co-polyester resins. During this process, the intrinsic viscosity of the co-polyester is controlled between 0.6-0.64 dl/g. The resulting polymer is cut into granules, dried and crystallized for 6 hours under 180° C. nitrogen gas. The resulting mixture undergoes solid phase condensation/aggregation reaction at reaction temperature of 225° C. for 20 hours and with an intrinsic viscosity between 0.76-0.86 dl/g. After the solid condensation/aggregation process, the polyester particles are processed into polyester bottles through 280° C. ejectors.

### EXAMPLE OF EXPLOITATION 2-3

This example is similar to exploitation 1, except that adjustments are made to the 2,6 naphthalene dicarboxylate and the TINUVIN*234. See table 1 results below.

### EXAMPLE OF COMPARISON 1

PET oligomer 12.11 Kg and EG 3.87 Kg are added into an electric heated stainless steel 30 litre reactor, agitated and heated under atmosphere to 260° C., and EG in the amount of 1200-1400 ml is collected. Before the condensation reaction, the following ingredients are subsequently added: 450 ppm antimony acetate condensation catalyst, 140 ppm cobalt acetate, and 0.25 mol % 2,6-naphthalene dicarboxylate.

Next, the reactor is vacuumed and decreased to pressures below 1 mmHg to perform the pre-polymerization reaction at a temperature of 270° C., and to perform subsequently the main polymer reaction at 280° C. to produce the co-polyester resins. During this process, the intrinsic viscosity of the co-polyester is controlled between 0.6-0.64 dl/g. The resulting polymer is cut into granules, dried and crystallized for 6 hours under 180° C. nitrogen gas. The resulting mixture undergoes solid phase condensation/aggregation reaction at reaction temperature of 225° C. for 20 hours and with an intrinsic viscosity between 0.76-0.86 dl/g. After the solid condensation/aggregation process, the polyester particles are processed into polyester bottles through 280° C. ejectors.

### EXAMPLE OF COMPARISON 2

PET oligomer 12.11 Kg and EG 3.87 Kg are added into an electric heated stainless steel 30 litre reactor, agitated and heated under atmosphere to 260° C., and EG in the amount of 1200-1400 mL is collected. Before the condensation reaction, the following ingredients are subsequently added: 450 ppm antimony acetate condensation catalyst, 140 ppm cobalt acetate, and 0.25 mol % 2,6-naphthalene dicarboxylate. Next, the reactor is vacuumed and decreased to pressures below I mmHg to perform the pre-polymerization reaction at a temperature of 270° C., and to subsequently perform the main polymer reaction at 280° C. to produce the co-polyester resins. During this process, the intrinsic viscosity of the co-polyester is controlled between 0.6-0.64 dl/g. The resulting polymer is cut into granules, dried and crystallized for 6 hours under 180° C. nitrogen gas. The resulting mixture undergoes solid phase condensation/aggregation reaction at reaction temperature of 225° C. for 20 hours and with an intrinsic viscosity between 0.76-0.86 dl/g. After the solid condensation/aggregation process, the polyester particles are processed into polyester bottles through 280° C. ejectors.

### EXAMPLE OF COMPARISON 3-6

The operation is similar to example 2, except that the addition ratios of 2,6 naphthalene dicarboxylate and TINUVIN*234 are adjusted. See table 1 results below. From table 1 below, it is observed that addition of 0.25 mol % 2,6 naphthalene dicarboxylate alone to the polyester composition had little effect on ultraviolet radiation over 360 nm wavelengths. Similarly, addition of TINUVIN*234 alone had poor covering effect against ultraviolet radiation above and at 360 nm wavelengths. In contrast, the polyester bottle slightly mixed with 2,6-naphthalene dicarboxylate and TINUVAN * 234 drastically reduced ultraviolet penetration, while maintaining haze value levels at a minimum.

### EXAMPLE OF COMPARISON 7

Except for adding 0.25 mol % of 2,6-naphthalene dicarboxylate and 50 ppm of 20 nm ferric oxide inorganic ultraviolet absorbent, comparison example 7 is similar to implementation example 1. See table 2 for result below.

### EXAMPLE OF COMPARISON 8

Comparison example 8 is similar to comparison example 7, except that the concentration of the 20 nm ferric oxide inorganic ultraviolet absorbent is 100 ppm instead of 50 ppm. See table 2 for results below.

### EXAMPLE OF COMPARISON 9

Comparison example 9 is similar to comparison example 7, except that the particle size and concentration of the ferric oxide inorganic ultraviolet absorbent are 0.27 micrometers and 200 ppm respectively. See table 2 for results below.

From table 2, the smaller the size of inorganic absorbent particles added to the polyester composition mixed with 0.25% mol of 2,6-naphthalene dicarboxylate, the higher the absorbent concentration added. Increased concentration of the inorganic absorbent results in secondary conglomeration, reduces penetration effect against ultraviolet radiation and results in higher haze values.

TABLE 1

| | 2,6 | Adding | | Ultraviolet | Ultraviolet | Ultraviolet |
|---|---|---|---|---|---|---|
| | Naphthalene | amount of | | penetration | penetration | penetration |
| | dicarboxylate | TINUVIN * | | rate T % | rate T % | rate T % |
| | (NDC) mol % | 234 ppm | Haze | at 360 nm | at 370 nm | at 380 nm |
| Example 1 | 0.25 | 300 | 0.7 | 6.5 | 47.5 | 66.5 |
| Example 2 | 0.25 | 500 | 0.4 | 9.7 | 47.4 | 64.3 |
| Example 3 | 0.50 | 500 | 0.4 | 2.4 | 38.0 | 61.6 |
| Comparative | 0 | 0 | 1.1 | 70.8 | 78.4 | 81.6 |
| example 1 | | | | | | |
| Comparative | 0.25 | 0 | 1.1 | 15.0 | 69.2 | 80.5 |
| example 2 | | | | | | |
| Comparative | 0 | 300 | 1.6 | 50.2 | 60.5 | 68.6 |
| example 3 | | | | | | |
| Comparative | 0 | 600 | 0.4 | 37.3 | 47.3 | 59.0 |
| example 4 | I. | | | | | |
| Comparative | 0.25 | 100 | 0.4 | 15.6 | 63.8 | 75.7 |
| example 5 | | | | | | |
| Comparative | 0.10 | 500 | 0.4 | 25.4 | 56.2 | 67.6 |
| example 6 | | | | | | |

TABLE 2

| | 2,6 | | | | Ultraviolet | Ultraviolet | Ultraviolet |
|---|---|---|---|---|---|---|---|
| | Naphthalene | Ferroferric oxide | | | penetration | penetration | penetration |
| | dicarboxylate | Adding | Particle | | rate T % | rate T % | rate T % |
| | (NDC) mol % | amount ppm | size | Haze | at 360 nm | at 370 nm | at 380 nm |
| Comparative | 0.25 | 50 | 20 nm | 1.1 | 14.1 | 63.1 | 74.8 |
| example 7 | | | | | | | |
| Comparative | 0.25 | 100 | 20 nm | 1.5 | 14.1 | 61.2 | 71.8 |
| example 8 | | | | | | | |
| Comparative | 0.25 | 200 | 0.27 μm | 9.4 | 13.0 | 58.3 | 69.8 |
| example 9 | | | | | | | |

What is claimed is:

1. An uv-resistant polyester composition capable of being blown molded into polyester bottles/vessels of desired shapes comprising:
(a) azimido-benzene ultraviolet absorbent; and
(b) copolyester

2. The uv-resistant polyester composition according to claim 1, wherein said ultraviolet absorbent concentration added to said copolyester is between 10-1000 ppm.

3. The uv-resistant polyester composition according to claim 2, wherein said copolyester comprises 2,6-naphthalene dicarboxylate and pre-polymerized polyester.

4. The uv-resistant polyester composition according to claim 3, wherein said pre-polymerized polyester comprises polyethylene terephthalate and modified polyethylene terephthalate.

5. The uv-resistant polyester composition according to claim 4, wherein said 2,6-naphthalene dicarboxylate is between 0.01 to 2 mol % of the copolyester.

6. The uv-resistant polyester composition according to claim 4, wherein said prepolymerized polyester constitutes over 98% mol of the copolyester.

7. The uv-resistant polyester composition according to claim 4 wherein said 2,6 naphthalene dicarboxylate addition level to form the copolyester is between 0.01 to 2 mol % and said pre-polymerized polyester addition level to form the copolyester is over 98 mol % respectively.

8. The uv-resistant polyester composition according to claim 7, wherein said 2,6 naphthalene addition level is between 0.1-1.0 mol %.

9. The uv-resistant polyester composition according to claim 4, wherein said 2,6-naphthalene dicarboxylate in-process mixture comprises 25 wt % milled 2,6-naphthalene dicarboxylate and ethylene glycol slurry.

10. The uv-resistant polyester composition according to claim 5, wherein said 2,6-naphthalene dicarboxylate in-process mixture comprises 25 wt % milled 2,6 naphthalene dicarboxylate and ethylene glycol slurry.

11. The uv-resistant polyester composition according to claim 6, wherein said 2,6 naphthalene dicarboxylate in-process mixture comprises 25 wt % milled 2,6 naphthalene dicarboxylate and ethylene glycol slurry.

12. The uv-resistant polyester composition according to claim 7, wherein said 2,6-naphthalene dicarboxylate in-process mixture comprises 25wt % milled 2,6 naphthalene dicarboxylate and ethylene glycol slurry.

13. The uv-resistent polyester composition according to claim 8, wherein said dicarboxylate in-process mixture comprises 25wt % milled 2,6 naphthalene dicarboxylate and ethylene glycol slurry.

14. The uv-resistant polyester composition according to claim 1, wherein said ultraviolet absorbent is Ciba Geigy's TINUVIN * 234.

15. The uv-resistant polyester composition according to claim 12, wherein said ultraviolet absorbent is Ciba Geigy's TINUVIN * 234.

16. The uv-resistant polyester composition according to claim 14, wherein the addition level of TINUVIN* 234 is between 200 to 500 ppm.

17. The uv-resistant polyester composition according to claim 15, wherein the addition level of TINUVIN * 234 is between 200 to 500 ppm.

18. The uv-reisistant polyester composition according to claim 17, wherein said composition further comprises antioxidant, organic pigment and infrared absorbent.

19. The uv-resistant polyester composition according to claim 18, wherein the 2,6 naphthalene dicarboxylate slurry is added to the copolyester during mixing of naphthalene diacid and glycol or the during the esterification reaction.

20. The uv-resistant polyester composition according to claim 16, wherein said composition further comprises antioxidant, organic pigment and infrared absorbent.
